(19) United States
(12) Patent Application Publication
(10) Pub. No.: US 2005/0224996 A1
(43) Pub. Date: Oct. 13, 2005

(54) Hydrogen reduced water and method for preparing the same

(75) Inventor: Yoshiaki Yoshida, Toyama-shi (JP)

Correspondence Address: TOWNSEND & BANTA;c/o PORTFOLIO IP, PO BOX 52050, MINNEAPOLIS, MN, 55402, US

(73) Assignee: T.E.D Inc., Ltd.

(21) Appl. No.: 11/065,252

(22) Filed: Feb. 24, 2005

(30) Foreign Application Priority Data
Apr. 12, 2004 (JP) 2004-116534
Oct. 25, 2004 (JP) 2004-309914

(51) Int. Cl. B01D 47/02

(52) U.S. Cl. 261/76

(57) ABSTRACT

Highly reductive hydrogen reduced water, which is suitable for drinking, and which is superior to conventional reduced water, is produced by dissolving large quantities of hydrogen gas in raw water. A pressure vessel 6 is filled with hydrogen gas; the pressure of the hydrogen gas in the pressure vessel 6 is maintained within a predetermined range; and raw water is introduced into the pressure vessel 6. More particularly, the raw water is introduced into the pressure vessel 6 as a shower from a nozzle 7, provided at the upper interior of the pressure vessel 6. After contacting hydrogen gas with the raw water in the pressure vessel 6 and dissolving the hydrogen gas in the raw water by these means, the water is packaged and sealed in a highly airtight container, and heat sterilization is performed in this state.

### FIELD OF THE INVENTION

The present invention relates to hydrogen reduced water, having strong reducing power, more specifically, to a hydrogen reduced water suitable for drinking, for use in the manufacture of foodstuffs and for washing metals, as well as to a method for preparing the same.

### BACKGROUND OF THE INVENTION

Redox potential is an indicator for determining the oxidative or reductive capacity of water. Water (aqueous solutions) showing a negative redox potential is referred to as reduced water and is known to be reductive. Generally, the redox potential of tap water is +500 to +750 mV. The redox potential of well water and commercial mineral water is 0 to +500 mV, these being oxidative.

Conversely, reduced water shows a negative redox potential, and is effective in limiting the oxidization of metals and spoiling of food. When consumed as drinking water, it is said to eliminate active oxygen in the body, which is a cause of aging and pain, and to improve such health problems as allergic disorders, including pollen allergies, atopy, asthma, digestive disorders such as gastrointestinal tract disorders, and high blood pressure.

Reduced water is commonly produced by electrolysis. For example, in one conventional method of preparation, taking advantage of the fact that hydrogen molecules collect at the cathode in electrolysis of water, water having a high active-hydrogen concentration is removed at the cathode side as reduced water (as described in JP 2002-254078-A). In order to distinguish this from naturally occurring reduced water, reduced water produced by electrolysis is referred to as “electrolytically reduced water” or “alkaline reduced water” because the water at the cathode becomes alkaline.

In another conventional method, oxygen dissolved in the water is removed, not by electrolysis, but by blowing activated hydrogen gas through the water (see JP-08-276104-A). Furthermore, a method is known wherein the concentration of dissolved hydrogen in water within a water tank is increased by passing hydrogen gas through water in the water tank (see JP-2002-172317-A).

As a matter of course, reduced water produced by electrolysis of water (electrolytically reduced water), as described in JP-2002-254078-A, is alkaline, and the greater the negative value of the redox potential thereof, the more alkaline the water and the higher the pH value thereof. A problem exists in that, if the pH value is limited to approximately 9 to 10, which is suitable for drinking water, the redox potential will be approximately −150 mV, and the reductive capacity thereof is lowered.

Meanwhile, as described in JP-08-276104-A and JP-2002-172317-A, the redox potential of water can be rendered negative by blowing hydrogen gas therethrough. However, with methods where hydrogen gas is passed through the water (bubbling), the hydrogen gas dissolves only where it is in contact with the water, meaning that large amounts of hydrogen gas are not dissolved, and as it is difficult to recover the hydrogen gas that reaches the surface of the water without dissolving, large amounts of hydrogen gas are released into the atmosphere after passing through the water. Thus, large amounts of hydrogen gas are required for such dissolution processes, which is disadvantageous in that it is expensive.

Furthermore, a problem exists in that active hydrogen, which is the reductive radical, is highly unstable, and if left in nature, will be dispersed into the atmosphere so that the redox potential of the water becomes more positive and the reductive characteristic is lost when the water reaches the consumer.

### SUMMARY OF THE INVENTION

The present invention is a reflection of the situation described above, and an object of the present invention is to produce highly reductive reduced water by dissolving large amounts of hydrogen gas in water, which is suitable for drinking and which is superior to conventional reduced water.

In order to achieve the aforementioned object, the present invention provides a method for preparing hydrogen reduced water as described in the following embodiments:

(1) A method for preparing reduced water comprising the steps of: filling a pressure vessel with hydrogen gas; and contacting raw water with the hydrogen gas by introducing the raw water into the pressure vessel so as to dissolve the hydrogen gas in the raw water within the pressure vessel, while maintaining the pressure of the hydrogen gas in the pressure vessel within a predetermined range (1 to 100 atm, preferably 1.1 to 50 atm or 2 to 20 atm, and more preferably 2 to 10 atm).

(2) A method for preparing reduced water comprising the steps of: filling a pressure vessel with hydrogen gas; and contacting raw water with the hydrogen gas by introducing the raw water into the pressure vessel while spraying the raw water as a shower within the pressure vessel so as to dissolve the hydrogen gas in the raw water within the pressure vessel, maintaining the pressure of the hydrogen gas in the pressure vessel within a predetermined range.

(3) A method for preparing reduced water comprising the steps of: filling a pressure vessel with hydrogen gas; and contacting raw water with the hydrogen gas by introducing the raw water into the pressure vessel while spraying the raw water as a shower from a nozzle provided at the upper interior of the pressure vessel so as to dissolve the hydrogen gas in the raw water within the pressure vessel, maintaining the pressure of the hydrogen gas in the pressure vessel at 1 to 100 atm.

In each of the methods described hereinabove in embodiments (1) to (3) above, it is preferable that the raw water be introduced to the interior of the pressure vessel by a pressure pump or by the pressure of compressed gas.

Furthermore, after dissolving the hydrogen gas in the raw water within the pressure vessel, it is preferable that a highly airtight container be filled therewith and sealed. It is also preferable that heat sterilization be performed with the water packaged in the sealed highly airtight container. Note that a pouch made of a sheet material comprising a hydrogen gas barrier layer, a synthetic resin bottle having hydrogen gas barrier characteristics, a glass bottle, a metal bottle or a can may be used as the highly airtight container.

In each of the methods described hereinabove in (1) to (3), it is preferable that the raw water comprise a mineral. It is also preferable that an antioxidant substance be added to the raw water prior to contacting with the hydrogen gas. It should also be noted that the antioxidant substance may be at least one substance selected from the group consisting of an amino acid, ascorbic acid, a phenol compound, an oxy acid, phosphoric acid, a phosphoric acid derivative, a caffeic acid derivative and a flavonoid.

Furthermore, the present invention provides hydrogen reduced water produced by the methods described hereinabove in embodiments (1) to (3).

By virtue of the method of the present invention, by introducing raw water into a pressure vessel that is filled with hydrogen gas, so as to contact the water with the hydrogen gas, large quantities of hydrogen gas are dissolved in the raw water, allowing for the production of highly reductive reduced water. More particularly, by spraying the raw water as a shower, contact with the hydrogen gas is improved, thus improving the efficiency with which the hydrogen gas is dissolved therein. Moreover, the hydrogen gas in the pressure vessel is not dispersed into the atmosphere but is dissolved in the raw water without waste.

In addition, by spraying raw water within the pressure vessel from a nozzle provided at the upper interior of the pressure vessel, it is possible to disperse the raw water over a wide area, allowing for good contact with the hydrogen gas. Furthermore, as the nozzle is provided at the top of the pressure vessel, spraying of water from the nozzle is not impeded by raw water that has collected at the bottom of the pressure vessel, so that raw water is continually sprayed from the nozzle at high pressure, allowing good contact to be maintained between the raw water and the hydrogen gas.

Moreover, as the raw water is introduced to the interior of the pressure vessel by a pressure pump or by the pressure of compressed gas, even if the hydrogen gas is produced and exists at high pressure, it is possible to overcome this pressure and introduce hydrogen gas into the pressure vessel. More particularly, if compressed gas pressure is utilized, it is possible to introduce the raw water without using electricity.

Furthermore, as the raw water in which hydrogen gas has been dissolved is packaged in a highly airtight container, leakage of the hydrogen gas can be prevented and the initial highly reductive characteristics can be maintained for long periods of time. More particularly, as pouches made from sheet material having a hydrogen gas barrier layer, synthetic resin bottles having hydrogen gas barrier characteristics, glass bottles, metal bottles or cans are used for the highly airtight container, hydrogen gas permeation leakage is limited, which improves the effect of maintaining highly reductive characteristics.

In particular, when the aforementioned pouches are used, contact with air when filling with the reduced water is limited, which prevents the loss of reductive characteristics. In addition, after filling the highly airtight container with the raw water in which hydrogen gas has been dissolved, the highly airtight container is sealed, and heat sterilization is performed in this state, which prevents hydrogen gas from leaking to the exterior as a result of such processing. Moreover, the use of raw water containing a mineral such as calcium is desirable from the point of view of health, and the effect of the mineral increases the reductive characteristics.

It was also discovered that, by adding antioxidant substances to the raw water, the effect of maintaining reductive characteristics can be improved. Furthermore, even alkaline raw water can be adjusted to pH levels suitable for drinking by using an amino acid or ascorbic acid as the antioxidant substance. Meanwhile, the hydrogen reduced water of the present invention is produced by introducing raw water (particularly by spraying as a shower) into a pressure vessel filled with pressurized hydrogen gas, whereby a large amount of hydrogen gas is dissolved, so that the water becomes highly reductive and is suitable for drinking.

### BRIEF DESCRIPTION OF THE DRAWINGS

FIG. 1 is a box diagram illustrating an example of an apparatus for preparing hydrogen reduced water of the present invention.

FIG. 2 is a graph showing changes in redox potential over time according to calcium hydrochloride concentration.

FIG. 3 is a graph showing changes in redox potential over time according to the addition of ascorbic acid.

FIG. 4 is a graph showing changes in redox potential over time according to storage conditions.

### DETAILED DESCRIPTION OF THE INVENTION

Hereinafter, the method for preparing hydrogen reduced water according to the present invention is described. A first feature of this method is contacting hydrogen gas and raw water at a pressure within a predetermined pressure range. A pressure vessel is used for this purpose. The interior thereof is filled with hydrogen gas, the internal pressure (hydrogen gas pressure) of the pressure vessel is maintained within a predetermined range, and raw water is introduced to the interior of the pressure vessel under these conditions.

Specifically, the air within the pressure vessel is flushed out with hydrogen gas or aspirated using a vacuum pump, whereafter the interior of the pressure vessel is filled with hydrogen gas pressurized to 1 to 100 atm (101325 to 10132500 Pa), preferably 1.1 to 50 atm (111458 to 5066250 Pa) or 2 to 20 atm (202650 to 2026500 Pa), and more preferably 2 to 10 atm (202650 to 1013250 Pa). With the internal pressure maintained in the range described above, raw water that has been pressurized to a pressure greater than the internal pressure of the pressure vessel is supplied and introduced to the interior of the pressure vessel. Note that a pressure pump or the pressure of compressed gas can be used to introduce the raw water into the pressure vessel. Consequently, even if the hydrogen gas pressure within the pressure vessel is established at a high pressure, raw water can be introduced to the interior of the pressure vessel by pumping the raw water into the pressure vessel at a pressure sufficient to overcome the internal pressure of the vesel. More particularly, when the pressure of compressed gas is used, it is possible to introduce the raw water without using electricity.

Furthermore, the raw water that is introduced to the interior of the pressure vessel may be discharged from one end of a water supply pipe having a predetermined diameter, but spraying as a shower (including misting), by such means as, for example, a nozzle having a plurality of fine holes (for example, having diameters of 100 to 300 μm) mounted at the end of the water supply pipe, is preferable as it increases the area of contact with the hydrogen gas, allowing an increased amount of hydrogen gas to be dissolved. It is particularly preferable for the nozzle to be mounted at the upper interior of the pressure vessel, so that the nozzle will not be submerged in raw water that has accumulated at the bottom of the pressure vessel, allowing the raw water to be sprayed from the nozzle at high pressure and broadly dispersed within the pressure vessel.

According to the method described above, large quantities of hydrogen gas are dissolved in the raw water, allowing for the production of highly reductive reduced water, having a redox potential of −500 mV or less, which is greatly superior to the redox potential of −200 to −300 mV of conventional electrolytically reduced water. This is based on Henry's Law, which states that the amount of gas that dissolves in a specific quantity of liquid at a specific temperature is proportional to the pressure thereof. Thus, larger quantities of hydrogen gas can be dissolved in the raw water, than is achievable by blowing hydrogen gas into raw water at atmospheric pressure.

In order to increase the amount of hydrogen gas that dissolves in the raw water, it is advantageous to increase the pressure of the hydrogen gas within the pressure vessel, but at pressure of greater than 100 atm, the overall equipment, including the pressure vessel, must be implemented on a large scale. Thus, the upper limit for the pressure of the hydrogen gas is set at approximately 100 atm, preferably 50 atm or 20 atm, and more preferably 10 atm. Meanwhile, if the pressure of the hydrogen gas within the pressure vessel is lowered, the amount of hydrogen gas that dissolves in the raw water will be lowered by a corresponding amount, and therefore the lower limit for the pressure of the hydrogen gas is set to approximately 1 atm, preferably 1.1 atm, and more preferably 2 atm.

Note that hydrogen gas stored in a gas canister can be used directly, but it is preferable that this be activated to produce activated hydrogen, using plasma or the like. Furthermore, mains water, distilled water produced by distilling mains water, or demineralized water (pure water) can be used for the raw water, but natural water containing large quantities of minerals such as calcium, potassium, sodium, iron, zinc and magnesium is preferred. For example, many types of minerals were detected by precision microanalysis of ground water (well water) from Toyama City. These minerals were found at levels of a few dozen parts per million for those elements found in the largest quantities, such as notably calcium, which is an alkaline earth metal, and particularly sodium and potassium, which are alkaline metals, and at levels of a few parts per million for those elements that were found in the smallest quantities.

Specifically, these minerals (metals) readily form ions, which function as reducing agents that shift the redox potential of the raw water toward the negative. Accordingly, the use of raw water containing minerals that function as reducing agents is preferred, as it allows for a further heightened reducing effect due to the synergistic action thereof with the hydrogen gas. Note, however, that mains water having a low mineral content, to which minerals have been artificially added, can be used as the raw water.

Furthermore, it is preferable to add antioxidant substances to the raw water before contacting the same with the hydrogen gas. By these means it is possible to maintain the highly reductive characteristics through the action of the hydrogen gas and the minerals. Note that the antioxidant substance is a substance that is not harmful to humans, and amino acids (aspartic acid, arginine, ricin, alanine, glutamic acid, leucine, isoleucine, valine, proline amino acids and the like), ascorbic acid, phenol compounds (tocopherol, guaiac, nordihydroguaiaretic acid: NDGA), oxy acids (citric acid, tartaric acid, malic acid and the like), phosphoric acid and derivatives thereof (phytin acid, lecithin and the like), caffeic acid derivatives (chlorogenic acid, dihydrocaffeic acid and the like) and flavonoids can be used at least individually, or preferably in mixtures of several of the above.

Raw water containing hydroxides such as calcium hydroxide can shift the redox value toward the negative, but if hydroxides of these sorts of metals are dissolved in the raw water, the pH value thereof increases and the water becomes alkaline. Specifically, if the water is excessively alkaline, it is not suitable for drinking, and it becomes necessary to adjust this toward the neutral range. In this light, antioxidant substances comprising acids such as described above function as pH adjusters capable of adjusting alkaline raw water toward the neutral range, and depending on the amount thereof added, even strongly alkaline raw water containing large amounts of calcium hydroxide can be adjusted to a pH value in the neutral range (for example, pH 5.8 to 8.6) so as to produce neutral reduced water.

In another embodiment of the present invention, a highly airtight container, is provided. For example, an aluminium pouch made of a sheet material comprising an aluminum layer that serves as a hydrogen gas barrier layer may be used. Such an aluminum pouch is a well-known flexible container formed by overlaying two sheets of material comprising aluminium foil sandwiched between two layers of plastic film (polyester/polypropylene or nylon/polypropylene) and heat-sealing the peripheral edges thereof. This pouch can be filled with the hydrogen reduced water in a flattened state, so that the hydrogen reduced water does not come into contact with air; and by, for example, heat-sealing the filling aperture immediately after filling with the hydrogen reduced water, it is possible to completely eliminate leakage of the hydrogen gas, so that the packaged hydrogen reduced water maintains the reducing power that was present at the time of filling for a long period of time.

Furthermore, by virtue of a pouch such as described above, after packaging the hydrogen reduced water, adequate sterilization can be performed rapidly. Hot water at 700 to 85° C. and, preferably water at 80° C., can be used for such sterilization, and the pouch (highly airtight container) in which the hydrogen reduced water is packaged can be immersed therein for approximately 30 minutes, but hot water or heated steam may also be blown against the pouch. Note that heat sterilization such as described above may be omitted if the filling operation is performed in a sterile room.

It will be appreciated that the hydrogen gas barrier layer is not limited to aluminum foil, but may also be made of other metal foils, resin films such as PVDC or EVOH or vapor deposited glass, aluminum or other metals. Furthermore, aluminium or steel cans, glass bottles having metal caps, metal bottles made from materials such as aluminium and steel, or synthetic resin bottles given hydrogen gas barrier characteristic by vapor deposition of metals or lamination of a plurality of resins can also be used as the highly airtight container. However, with rigid cans or bottles made of hard materials, even if the container itself has hydrogen gas barrier characteristics, at times such as when the container is filled with the reduced water, the reduced water comes into contact with air, and the reducing power thereof is somewhat lowered as compared to the time at which the hydrogen gas was dissolved. Accordingly, a pouch such as described above is most suitable for use as the highly airtight container in the present invention.

Note that polyethylene terephthalate bottles (PET bottles), which are currently in wide use as beverage containers, are not suitable, as the hydrogen gas escapes to the exterior thereof through the walls of the container so that, without being opened, the redox potential gradually shifts toward the positive. However, if the hydrogen reduced water of the present invention is packaged in PET bottles, the redox potential can be maintained negative by storing these in a hydrogen atmosphere.

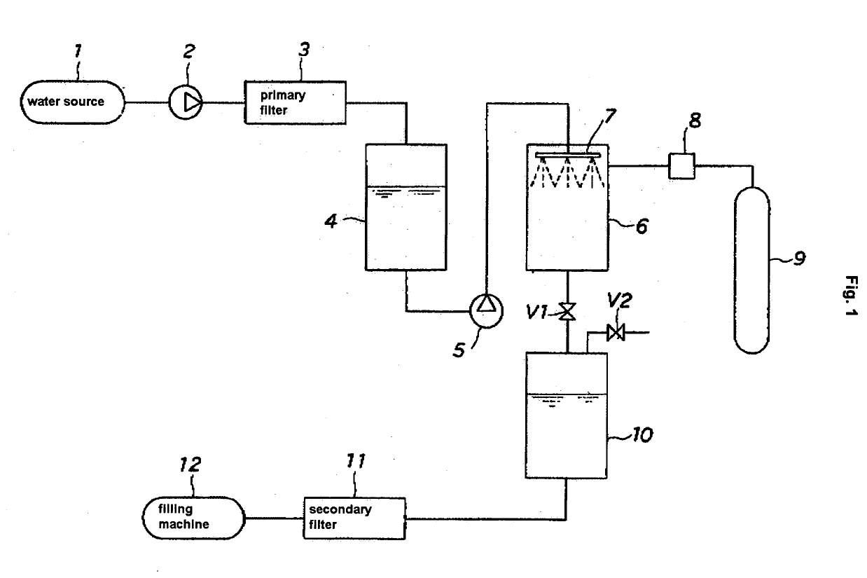

As shown in FIG. 1, reference numeral 1 indicates a water source such as a well. The present invention provides a water uptake pump 2 to take up raw water for processing from the water source. A primary filtration device 3 containing activated carbon or the like is connected to the water uptake pump 3, and a fixed amount of raw water having passed through this primary filtration device 3 is stored in a raw water storage tank 4. Note that a water level sensor is provided in the raw water storage tank 4, and the water uptake pump 2 is driven in accordance with the detection signal therefrom so that a constant amount of raw water is held in the raw water storage tank 4.

Furthermore, as illustrated in FIG. 1, a pressure pump 5 takes up raw water from within the raw water storage tank 4, pressurize it, and introduces the raw water to a pressure vessel 6. In particular, raw water fed by the pressure pump 5 is sprayed into the pressure vessel 6 by a nozzle 7, this nozzle 7 being fixed at the upper interior of the pressure vessel 6 and connected to a supply pipe, which extends from the raw water storage tank 4. Furthermore, the pressure vessel 6 is connected to a hydrogen gas canister 9 by way of a regulator 8.

High-pressure hydrogen gas (approximately 20 MPa) stored in the hydrogen gas canister 9 is adjusted to a predetermined pressure (0.6 MPa in the present embodiment) by way of the regulator 8. The pressure vessel 6 is filled with said hydrogen gas by way of the regulator 8, whereafter the hydrogen gas pressure in the pressure vessel 6 is maintained within a predetermined range (0.6 to 0.7 MPa in the present embodiment). The raw water in the raw water storage tank 4 is introduced into the pressure vessel 6 by running the pressure pump 5 so that the raw water is sprayed as a shower into the pressure vessel 6 from the nozzle 7.

Consequently, while the raw water is widely dispersed downwards within the pressure vessel 6 from the top thereof, good contact is made between the raw water and the high-pressure hydrogen gas so that large quantities of hydrogen gas are dissolved in the raw water. The raw water in which hydrogen gas has been dissolved is then collected in a product storage tank 10, connected to the bottom of the pressure vessel 6. Thereafter, it is supplied to a filling machine 12 by way of a secondary filtration unit 11, fitted with an ultrafiltration membrane. The filling machine 12 then packages the raw water in a highly airtight container, and heat sterilization is performed.

Before introducing the raw water into the pressure vessel 6, valves V1 and V2 are opened, and the air is flushed out of the pressure vessel 6 and the product storage tank 10 by the hydrogen gas in the hydrogen gas canister 9, whereafter the valves V1 and V2 are closed and the pressure vessel 6 is filled with hydrogen gas until a predetermined pressure is reached. However, a vacuum pump can also be used to remove the air from the interior of the pressure vessel 6. Furthermore, in the nozzle 7, a plurality of small holes are formed in a coiled pipe, but the present invention is not limited to this configuration.

Moreover, in the embodiment described above, raw water is introduced into the pressure vessel 6 by the pressure pump 5, but, alternatively, raw water can be introduced into the pressure vessel 6 by way of pressure resulting from hydrogen gas or another compressed gas, by connecting the hydrogen gas canister 9 or another gas canister to the raw water storage tank 4.

Experiment 1

This experiment investigated the influence of storage conditions on the redox potential of water in which hydrogen gas had been dissolved (hydrogen reduced water). Note that the redox potential was measured using a redox potential meter (DKK-TOA model HM-21 P, reference electrode: silver-silver chloride). Furthermore, water purified using an ion exchange resin was used for the preparation of the hydrogen reduced water, 250 ml of which was placed in a gas washing bottle, and hydrogen gas was blown in for 30 minutes at a rate of 14.3 ml/sec. The hydrogen reduced water produced (test water) was stored according to the following four methods, and the redox potentials of each of the test water samples were measured every other day.
(1) unsealed storage at room temperature
(2) unsealed storage in a refrigerator at 4° C.
(3) sealed storage at room temperature
(4) sealed storage in a refrigerator at 4° C.

Immediately after dissolving the hydrogen gas, the redox potential of each of the test water samples was −320 mV, but this moved toward the positive over time. Although there were some differences in the redox potentials of the test water samples stored under different conditions, after one week the redox potentials of all of these was +300 mV or greater.

Experiment 2

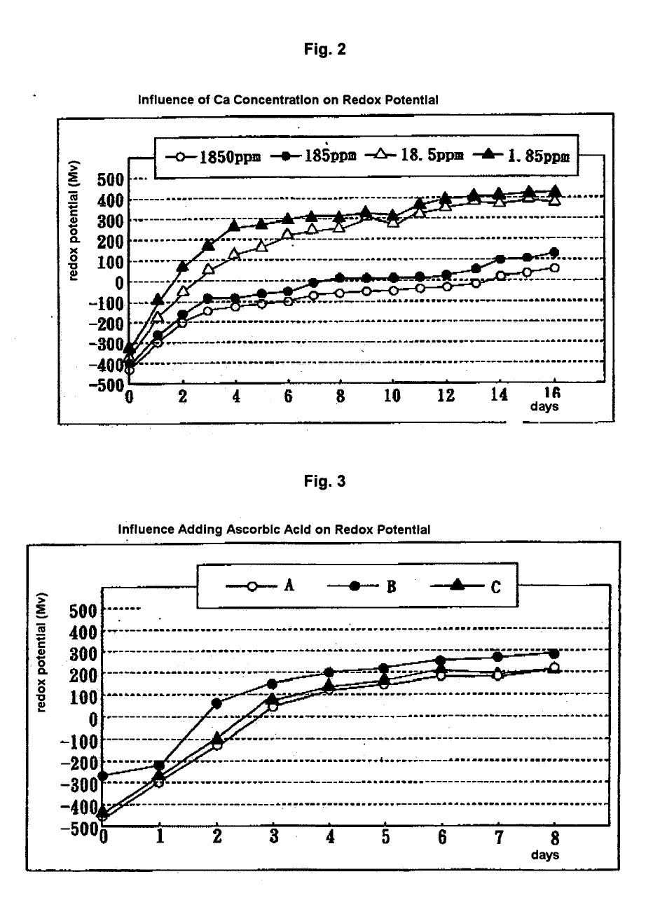

This test investigated the influence of the concentration of minerals contained in the raw water on redox potential. For these purposes, calcium hydroxide was added to pure water to prepare a saturated aqueous solution of calcium hydroxide (1850 ppm), which was diluted 10 times (185 ppm), 100 times (18.5 ppm) and 1000 times (1.85 ppm), whereafter 250 ml of each of these solutions were placed in gas washing bottles and hydrogen gas was passed through to prepare a total of four test water samples. Next, each of the test water samples was left unsealed, and the redox potential thereof was measured every other day. The results are shown in FIG. 2. The vertical axis indicates redox potential and the horizontal axis indicates number of days.

FIG. 2 shows that low redox potential was better maintained with higher concentrations of calcium in the test water samples. Specifically, the test water sample having a calcium concentration of 1850 ppm maintained a negative redox potential for 13 days. Note that it was possible to bring the initial redox potential of all of the test water samples to no greater than −320 mV.

Experiment 3

This experiment investigated the effect of adding an antioxidant substance (ascorbic acid). A quantity of 250 ml of an aqueous solution of calcium hydroxide at a concentration of 300 ppm having a pH of 12 was placed in a 250 ml gas washing bottle, and L-ascorbic acid was added until the pH reached 7. Furthermore, for comparison, 250 ml of pure water to which an amount of L-ascorbic acid equal to that described above was added, and 250 ml of pure water to which nothing had been added, were placed in gas washing bottles, and hydrogen gas was passed therethrough to prepare a total of three test water samples. Next, each of the test water samples was left unsealed, and the redox potential thereof was measured every other day. The results are shown in FIG. 3. The vertical axis indicates redox potential, and the horizontal axis indicates number of days.

As shown in FIG. 3, the redox potentials of the neutral test water A, containing calcium hydroxide and ascorbic acid, and test water C, consisting of pure water, were not seen to change greatly over time, but the initial redox potential of test water B, containing only ascorbic acid, was high, and the redox potential was seen to move to the positive in a relatively short period of time.

Experiment 4

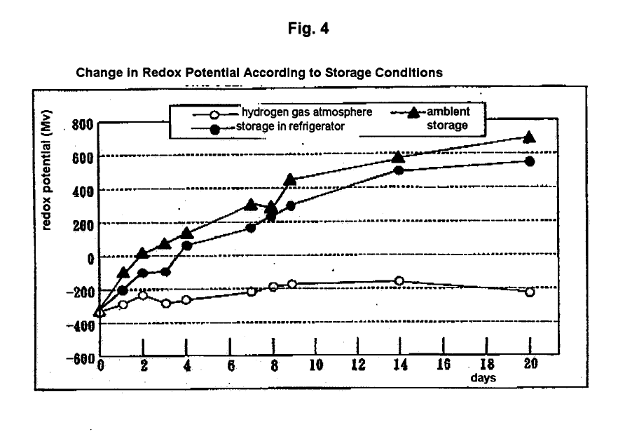

This experiment investigated whether or not PET bottles are effective containers for hydrogen reduced water. First, ion exchange water was placed in three PET bottles (500 ml), and after passing hydrogen gas therethrough, the bottles were sealed. Next, one PET bottle was placed in a vacuum desiccator (square, width 30 cm, depth 30 cm, height 25 cm, storage capacity approximately 20 liters), and the pressure was reduced with a vacuum pump. Thereafter, hydrogen gas was introduced to the vacuum desiccator until atmospheric pressure was reached, and the bottle was stored under these conditions. Meanwhile, the other PET bottles were stored in a refrigerator and at room temperature, respectively. The changes in redox potential in the test water in each of the PET bottles were then measured. The results are shown in FIG. 1 and FIG. 4.

TABLE 1
Change in Redox Potential Over Time

| | Hydrogen Gas | | Room |
|---|---|---|---|
| | Atmosphere | Refrigerator | Temperature |
| | (mV) | (mV) | (mV) |
| Immediately | −351 | −352 | −347 |
| After Dissolving | | | |
| Hydrogen Gas | | | |
| After 1 day | −322 | −200 | −105 |
| After 2 days | −229 | −106 | 15 |
| After 3 days | −299 | −103 | 83 |
| After 4 days | −274 | 79 | 125 |
| After 7 days | −207 | 185 | 304 |
| After 8 days | −195 | 216 | 283 |
| After 9 days | −190 | 294 | 443 |
| After 14 days | −183 | 509 | 587 |
| After 20 days | −213 | 543 | 681 |

The redox potential for the PET bottle that was stored inside the vacuum desiccator was maintained at a negative value for 20 days, while the others shifted to the positive in a few days. Consequently, it was determined that PET bottles lack a hydrogen gas barrier (shielding) characteristic. It was, however, found that low redox potential can be maintained by storage in a hydrogen gas atmosphere.

Experiment 5

In this experiment, a pressure vessel was filled with hydrogen gas to a pressure of 8 atm, and raw water was introduced to the interior thereof at a pressure of 12 atm (shower spraying). After adequately contacting the raw water and the hydrogen gas in the pressure vessel by these means, the water was sealed in an aluminium pouch, which was immersed in 80° C. water for heat sterilization. Note that the redox potential of the hydrogen reduced water at the time of filling the aluminium pouch was −600 mV, and it was found that the redox potential was lower as a result of contacting the raw water and the hydrogen gas under pressure than at atmospheric pressure. This is believed to be because greater amounts of hydrogen gas dissolve in the raw water.

Furthermore, when an aluminium pouch was opened after storage at room temperature for two weeks and the redox potential of the contents thereof (hydrogen reduced water) was measured, at −570 mV, there was no major change from the initial value, showing that the aluminium pouch was an effective highly airtight container for the hydrogen reduced water according to the present invention.

Note that, when an experiment was performed in the same manner as described above, using an aluminium bottle fitted with a screw-type aluminium cap as the highly airtight container, as with the aluminium pouch, there was no major change in the redox potential of the hydrogen reduced water. The initial value thereof was −600 mV, and after two weeks the redox potential was found to have been maintained low at −560 mV.

Hereinabove the present invention has been described, but the hydrogen reduced water according to the present invention is not limited in usage to drinking, but is also suitable for use in cleaning metals and cooking.

1. A method for preparing hydrogen reduced water comprising the steps of:
filling a pressure vessel having an interior with hydrogen gas; and
contacting raw water with said hydrogen gas by introducing said raw water into said pressure vessel so as to dissolve said hydrogen gas in said raw water within said pressure vessel, while maintaining the pressure of said hydrogen gas in said pressure vessel within a predetermined range.

2. A method for preparing hydrogen reduced water comprising the steps of:
filling a pressure vessel having an interior with hydrogen gas; and
contacting raw water with said hydrogen gas by introducing said raw water into said pressure vessel while spraying said raw water as a shower within said pressure vessel so as to dissolve said hydrogen gas in said raw water within said pressure vessel, while maintaining the pressure of said hydrogen gas in said pressure vessel within a predetermined range.

3. A method for preparing hydrogen reduced water comprising the steps of:
filling a pressure vessel having an interior with hydrogen gas; and
contacting raw water with said hydrogen gas by introducing said raw water into said pressure vessel while spraying said raw water as a shower from a nozzle provided at the upper interior of said pressure vessel so as to dissolve said hydrogen gas in said raw water within said pressure vessel, maintaining the pressure of said hydrogen gas in said pressure vessel at 1 to 100 atm.

4. The method for preparing hydrogen reduced water as recited in claim 1, wherein said raw water is introduced to the interior of said pressure vessel by a pressure pump or by the pressure of compressed gas.

5. The method for preparing hydrogen reduced water as recited in claim 1, wherein, after dissolving said hydrogen gas in said raw water within said pressure vessel to produce hydrogen reduced water, a highly airtight container is filled therewith and sealed.

6. The method for preparing hydrogen reduced water as recited in claim 1, wherein, after dissolving said hydrogen gas in said raw water within said pressure vessel to produce hydrogen reduced water, a highly airtight container is filled therewith and sealed, and heat sterilization thereof is performed.

7. The method for preparing hydrogen reduced water as recited in claim 5, wherein a pouch made of a sheet material comprising a hydrogen gas barrier layer, a synthetic resin bottle having hydrogen gas barrier characteristics, a glass bottle, a metal bottle or a can is used as said highly airtight container.

8. The method for preparing hydrogen reduced water as recited in claim 1, wherein said raw water comprises a mineral.

9. The method for preparing hydrogen reduced water as recited in 1, wherein an antioxidant substance is added to said raw water prior to contacting with said hydrogen gas.

10. The method of preparing hydrogen reduced water as recited in claim 9, wherein said antioxidant substance is at least one substance selected from the group consisting of an amino acid, ascorbic acid, a phenol compound, an oxy acid, phosphoric acid, a phosphoric acid derivative, a caffeic acid derivative and a flavonoid.

11. Hydrogen reduced water produced by the method recited in claim 1.

12. A method for preparing hydrogen reduced water as recited in claim 2, wherein said raw water is introduced to the interior of said pressure vessel by a pressure pump or by the pressure of compressed gas.

13. A method for preparing hydrogen reduced water as recited in claim 3, wherein said raw water is introduced to the interior of said pressure vessel by a pressure pump or by the pressure of compressed gas.

14. A method for preparing hydrogen reduced water as recited in claim 2, wherein, after dissolving said hydrogen gas in said raw water within said pressure vessel to produce hydrogen reduced water, a highly airtight container is filled therewith and sealed.

15. A method for preparing hydrogen reduced water as recited in claim 3, wherein, after dissolving said hydrogen gas in said raw water within said pressure vessel to produce hydrogen reduced water, a highly airtight container is filled therewith and sealed.

16. A method for preparing hydrogen reduced water as recited in claim 2, wherein, after dissolving said hydrogen gas in said raw water within said pressure vessel to produce hydrogen reduced water, a highly airtight container is filled therewith and sealed, and heat sterilization thereof is performed.

17. A method for preparing hydrogen reduced water as recited in claim 3, wherein, after dissolving said hydrogen gas in said raw water within said pressure vessel to produce hydrogen reduced water, a highly airtight container is filled therewith and sealed, and heat sterilization thereof is performed.

18. The method for preparing hydrogen reduced water as recited in claim 6, wherein a pouch made of a sheet material comprising a hydrogen gas barrier layer, a synthetic resin bottle having hydrogen gas barrier characteristics, a glass bottle, a metal bottle or a can is used as said highly airtight container.

19. A method for preparing hydrogen reduced water as recited in claim 2, wherein said raw water comprises a mineral.

20. A method for preparing hydrogen reduced water as recited in claim 3, wherein said raw water comprises a mineral.

21. The method for preparing hydrogen reduced water as recited in claim 2, wherein an antioxidant substance is added to said raw water prior to contacting with said hydrogen gas.

22. The method for preparing hydrogen reduced water as recited in claim 3, wherein an antioxidant substance is added to said raw water prior to contacting with said hydrogen gas.

23. Hydrogen reduced water produced by the method recited in claim 2.

24. Hydrogen reduced water produced by the method recited in claim 3.

25. The method of preparing hydrogen reduced water as recited in claim 21, wherein said antioxidant substance is at least one substance selected from the group consisting of an amino acid, ascorbic acid, a phenol compound, an oxy acid, phosphoric acid, a phosphoric acid derivative, a caffeic acid derivative and a flavonoid.

26. The method of preparing hydrogen reduced water as recited in claim 22, wherein said antioxidant substance is at least one substance selected from the group consisting of an amino acid, ascorbic acid, a phenol compound, an oxy acid, phosphoric acid, a phosphoric acid derivative, a caffeic acid derivative and a flavonoid.
